(19) United States
(12) Patent Application Publication
(10) Pub. No.: US 2019/0064827 A1
(43) Pub. Date: Feb. 28, 2019

(54) SELF-DRIVING ASSISTANCE DEVICE AND COMPUTER PROGRAM

(71) Applicant: AISIN AW CO., LTD., Anjo-shi, Aichi-ken (JP)

(72) Inventors: Hirohiko GOTO, Okazaki (JP); Masaki TAKANO, Susono (JP); Kuniaki TANAKA, Nagoya (JP)

(73) Assignee: AISIN AW CO., LTD., Anjo-shi, Aichi-ken (JP)

(21) Appl. No.: 16/076,569

(22) PCT Filed: Feb. 28, 2017
(86) PCT No.: PCT/JP2017/007845

§ 371 Date: Aug. 8, 2018

(30) Foreign Application Priority Data
Mar. 8, 2016 (JP) 2016-044288

(51) Int. Cl. G05D 1/02; G01C 21/34

(52) U.S. Cl. CPC G05D 1/0212; G01C 21/3415; G01S 19/13; G05D 1/0278; G05D 2201/0213

(57) ABSTRACT

Self-driving assistance devices and programs detect a location of a vehicle and identify a planned travel route on which the vehicle travels from now on, based on the detected location of the vehicle. The devices and programs provide self-driving assistance of the vehicle according to the identified planned travel route. When a plurality of candidates for the location of the vehicle are detected after the vehicle passes through a divergence point, the devices and programs provide self-driving assistance of the vehicle according to a determined planned travel route, which is identified by the processor before the vehicle passes through the divergence point.

### TECHNICAL FIELD

Related technical fields include self-driving assistance devices and computer programs that provide self-driving assistance in a vehicle.

### BACKGROUND

In recent years, for vehicle's travel modes, there has been newly proposed a self-driving assistance system that aids in user's vehicle driving by performing some or all of user's driving operations on the vehicle side, in addition to manual travel in which a vehicle travels based on user's driving operations. For example, JP 2014-199588 A proposes a technique in which a vehicle's travel pattern is identified by accumulating and learning the past travel history of a vehicle, to provide deceleration assistance for decelerating to a target speed when a vehicle reaches a point where a deceleration operation is expected to be performed.

In the self-driving assistance system, in addition to the above-described deceleration assistance, for example, vehicle control such as steering, drive sources, and brakes is also automatically performed such that the vehicle continuously travels near the center of the same lane at a preset speed or with a constant distance maintained from a vehicle ahead. Here, travel by the self-driving assistance system has an advantage in that the burden of user's driving can be reduced; however, to appropriately perform travel by self-driving assistance, it is important to accurately identify on which route the vehicle travels currently and from now on a road around the vehicle.

### SUMMARY

For example, when, as shown in FIG. 11, a linear road 102 and a curved road 103 are connected at a divergence point ahead of a vehicle that travels on a road 101, the control operation of self-driving assistance varies depending on which way the vehicle travels at the divergence point. Namely, when the vehicle travels on the curved road 103, the vehicle needs to be decelerated to a speed according to the radius of curvature of a curve, but when the vehicle travels on the linear road 102, deceleration is not required and it is desirable that the vehicle travel at a constant speed as much as possible to prevent traffic flow disruption. Therefore, unless a route on which the vehicle travels can be identified, appropriate self-driving assistance cannot be provided. However, conventional location detection by the GPS and location detection by an autonomous inertial navigation method have a problem that in a section where a plurality of routes which are matching candidates for a vehicle location are present close to each other (in the example shown in FIG. 11, a section with a predetermined distance from the start of the divergence point; hereinafter, referred to as unidentified section), it is difficult to identify on which route the vehicle is located (i.e., it is difficult to identify a route on which the vehicle travels).

JP 2014-199588 A proposes a technique in which upon traveling in an unidentified section such as that described above, a point where deceleration control starts is allowed to be located more frontward than a divergence point, by which a situation in which self-driving assistance is not provided is prevented. However, the technique of JP 2014-199588 A is a technique that gives up the identification of which route the vehicle travels on and prevents at least the occurrence of a situation in which self-driving assistance is not provided. Therefore, consequently, there is a possibility that self-driving assistance may be provided in a situation in which self-driving assistance is not supposed to be provided, or an operation of self-driving assistance that differs from an operation originally supposed to be performed may be performed.

Exemplary embodiments of the broad inventive principles described herein solve the above-described conventional problem, and provide a self-driving assistance device and a computer program that allow to provide appropriate self-driving assistance according to a vehicle situation even when there are a plurality of candidates for a current vehicle location.

To allow to provide appropriate self-driving assistance according to a vehicle situation, a self-driving assistance devices and programs detect a location of a vehicle and identify a planned travel route on which the vehicle travels from now on, based on the detected location of the vehicle. The devices and programs provide self-driving assistance of the vehicle according to the identified planned travel route. When a plurality of candidates for the location of the vehicle are detected after the vehicle passes through a divergence point, the devices and programs provide self-driving assistance of the vehicle according to a determined planned travel route, which is identified by the processor before the vehicle passes through the divergence point.

The “self-driving assistance” refers to a function of performing, instead of a driver, or aiding in at least some of driver's vehicle operations.

The expression “provide self-driving assistance” also includes the generation and provision of information used for self-driving assistance, in addition to vehicle control according to self-driving assistance.

According to the self-driving assistance device and the computer program that have the above-described configurations, even when there are a plurality of candidates for a current vehicle location after passing through a divergence point, by providing self-driving assistance according to a planned travel route that is identified with high accuracy before passing through the divergence point, self-driving assistance is prevented from being provided in a situation in which self-driving assistance is not supposed to be provided, or an operation of self-driving assistance that differs from an operation originally supposed to be performed is prevented from being performed, enabling to provide appropriate self-driving assistance according to a current vehicle situation.

### BRIEF DESCRIPTION OF DRAWINGS

FIG. 1 is a block diagram showing a configuration of a navigation device according to the present embodiment.

FIG. 2 is a diagram showing an example of map information stored in a map information DB for a road section.

FIG. 3 is a flowchart of a self-driving assistance program according to the present embodiment.

FIG. 4 is a flowchart of the self-driving assistance program according to the present embodiment.

FIG. 5 is a diagram describing a case in which a plurality of candidates for a vehicle location are obtained in a map matching process.

FIG. 6 is a diagram describing a method of identifying a planned travel route.

FIG. 7 is a diagram describing a case in which one planned travel route cannot be identified.

FIG. 8 is a diagram describing a section immediately after divergence.

FIG. 9 is a diagram describing a method of estimating a current vehicle location.

FIG. 10 is a diagram describing conditions on which self-driving assistance for a vehicle is continuously provided.

FIG. 11 is a diagram describing a problem of conventional art.

### DETAILED DESCRIPTION OF EXEMPLARY EMBODIMENTS

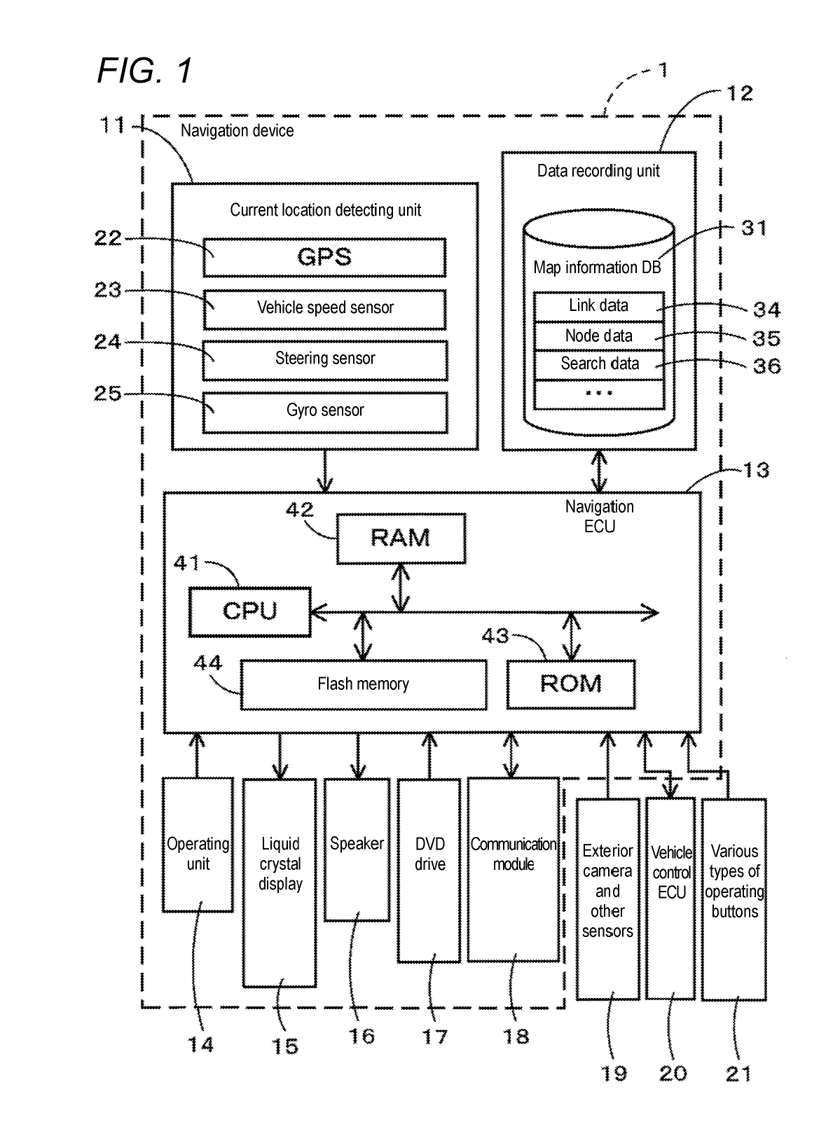

A self-driving assistance device will be described in detail below based on one embodiment that embodies a navigation device and with reference to the drawings. First, a schematic configuration of a navigation device 1 according to the present embodiment will be described using FIG. 1. FIG. 1 is a block diagram showing the navigation device 1 according to the present embodiment.

As shown in FIG. 1, the navigation device 1 according to the present embodiment has a current location detecting unit 11 that detects a current location of a vehicle having mounted thereon the navigation device 1; a data recording unit 12 having various types of data recorded therein; a navigation ECU 13 that performs various types of arithmetic processing based on inputted information; an operating unit 14 that accepts operations from a user; a liquid crystal display 15 that displays a map of an area around the vehicle, information about a guided route set on the navigation device 1, etc., to the user; a speaker 16 that outputs audio guidance on route guidance; a DVD drive 17 that reads a DVD which is a storage medium; and a communication module 18 that performs communication with information centers such as a probe center and a VICS (registered trademark: Vehicle Information and Communication System) center. (As used herein, the term “storage medium” does not encompass transitory signals). In addition, an exterior camera 19 and various types of sensors which are installed on the vehicle having mounted thereon the navigation device 1 are connected to the navigation device 1 through an in-vehicle network such as a CAN. Furthermore, a vehicle control ECU 20 that performs various types of control on the vehicle having mounted thereon the navigation device 1 is also connected in a two-way communicable manner. In addition, various types of operating buttons 21 mounted on the vehicle such as a self-driving start button are also connected.

Each component of the navigation device 1 will be described below in turn.

The current location detecting unit 11 includes a GPS 22, a vehicle speed sensor 23, a steering sensor 24, a gyro sensor 25, etc., and can detect the current location and orientation of the vehicle, vehicle travel speed, the current time, etc. Here, particularly, the vehicle speed sensor 23 is a sensor for detecting the movement distance and vehicle speed of the vehicle, and generates pulses according to the rotation of drive wheels of the vehicle and outputs a pulse signal to the navigation ECU 13. Then, the navigation ECU 13 counts the generated pulses and thereby calculates the rotational speed and movement distance of the drive wheels. The navigation device 1 does not need to include all of the above-described four types of sensors, and the navigation device 1 may be configured to include only one or a plurality of types of sensors of those sensors.

In addition, the data recording unit 12 includes a hard disk (not shown) serving as an external storage device and a storage medium; and a recording head (not shown) which is a driver for reading a map information DB 31, a predetermined program, etc., recorded on the hard disk, and writing predetermined data to the hard disk. The data recording unit 12 may have a flash memory, a memory card, or an optical disc such as a CD or a DVD, instead of the hard disk. Note also that the configuration may be such that the map information DB 31 is stored on an external server and the navigation device 1 obtains the map information DB 31 by communication.

Here, the map information DB 31 is storage means having stored therein, for example, link data 34 about roads (links), node data 35 about node points, search data 36 used for processes related to a route search and change, facility data about facilities, map display data for displaying a map, intersection data about each intersection, and retrieval data for retrieving points.

In addition, for the link data 34, the following data about each link forming a road is recorded: data representing the width, gradient, cant, bank, state of a road surface, merging section, road structure, number of lanes on the road, a location where the number of lanes is reduced, a location where the width becomes narrower, railroad crossing, etc., of the road to which the link belongs; for a corner, data representing the radius of curvature, an intersection, a T-junction, the entry and exit of the corner, etc.; for the attribute of the road, data representing a downhill slope, an uphill slope, etc.; and for the type of road, data representing a toll road such as a national expressway, an urban expressway, a freeway, a general toll road, and a toll bridge, in addition to a general road such as a national highway, a prefectural road, and a narrow street. Particularly, in the present embodiment, information is also stored that identifies a connection to a road for each lane (more specifically, the shape of a merging point or a divergence point, and which lane is connected to which road at the merging point or divergence point), in addition to road lane divisions.

Here, for the information that identifies road lane divisions and a connection to a road for each lane, specifically, the ‘number of lanes’, the ‘type of marking’, and the ‘type of lane connection’ are stored in the map information DB 31. The ‘number of lanes’ is information indicating the number of lanes forming a road (e.g., 1, 2, and 3). The ‘type of marking’ is information indicating, for each marking, the type of lane marking (e.g., a solid line, a broken line, and a guide zone). The ‘type of lane connection’ is information indicating, for each lane, how a lane forming a road changes (e.g., continue, add, disappear, divide, and combine).

The “guide zone” which is the ‘type of marking’ is a marking provided to allow vehicles to appropriately merge or diverge at a divergence point or a merging point, and has a type of marking where diagonal white lines are continuously drawn at predetermined intervals. In addition, the “continue” which is the ‘type of lane connection’ indicates that there is no increase or decrease of a lane. The “add” indicates an increase of a lane. The “disappear” indicates a decrease of a lane. The “divide” indicates an increase of a lane by one lane divided into a plurality of lanes. The “combine” indicates a decrease of a lane by a plurality of lanes combined into one lane. For information about the above-described ‘number of lanes’, ‘type of marking’, and ‘type of lane connection’, information is stored for each change point of a lane configuration in a road network across the country (a point where there is an increase or decrease of a lane, a point where the type of marking changes, etc.), the information being targeted for a section after the change point.

Then, the navigation ECU 13 obtains each information about the ‘number of lanes’, the ‘type of marking’, and the ‘type of lane connection’ in a vehicle's traveling direction from the map information DB 31, and can thereby identify road lane divisions and a connection to a road for each lane. For example, with the ‘number of lanes’, the number of lanes for each point can be identified. In addition, with the ‘type of marking’, when there is a merge into a main lane or there is an addition of a lane to the main lane, a boundary between the main lane and the newly merged or added lane (i.e., a division between the main lane and a lane other than the main lane) can be identified in addition to a section where lanes are merged and a section where a lane change can be made to a newly provided lane. In addition, with the ‘type of lane connection’, it can be identified, for each lane, whether the lane is an existing lane that still continues on, whether the lane is a newly added one, or whether the lane is one that disappears.

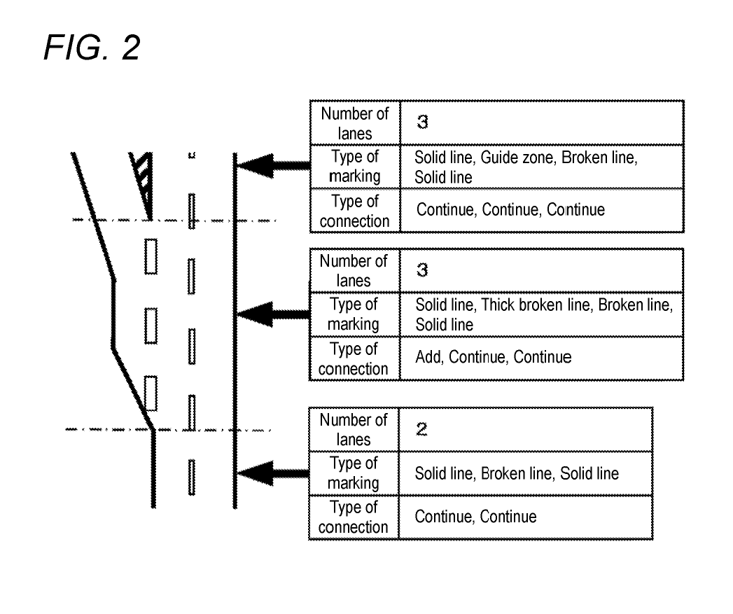

Here, FIG. 2 is a diagram showing an example of various types of information stored in the map information DB 31 for a road section. For example, for the road section shown in FIG. 2, the navigation ECU 13 can identify, by referring to each information, that a new lane is added to a main road including two lanes, at a divergence point and on the leftmost side and the added lane diverges in a direction different from the direction of other lanes.

In addition, for the node data 35, there is recorded data about the coordinates (locations) of actual road divergence points (including intersections, T-junctions, etc.) and of a node point that is set every predetermined distance for each road according to the radius of curvature, etc.; the attribute of a node indicating, for example, whether the node corresponds to an intersection; a connected link number list which is a list of link numbers of links connected to a node; an adjacent node number list which is a list of node numbers of nodes adjacent to a node through a link; the height (altitude) of each node point, etc.; and the like.

In addition, for the search data 36, various types of data are recorded that are used for a route search process for searching for a route from a point of departure (e.g., a current vehicle location) to a set destination. Specifically, cost calculation data is stored that is used to calculate search costs such as a cost in which the degree of appropriateness as a route for an intersection is converted into numbers (hereinafter, referred to as intersection cost), and a cost in which the degree of appropriateness as a route for a link forming a road is converted into numbers (hereinafter, referred to as link cost).

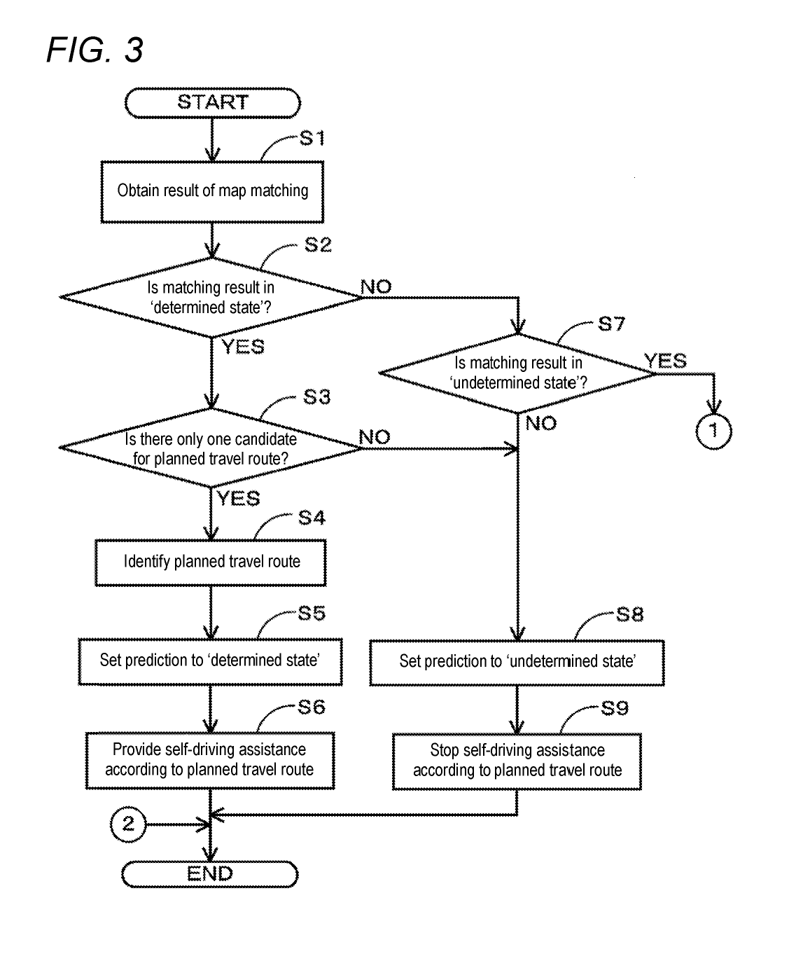

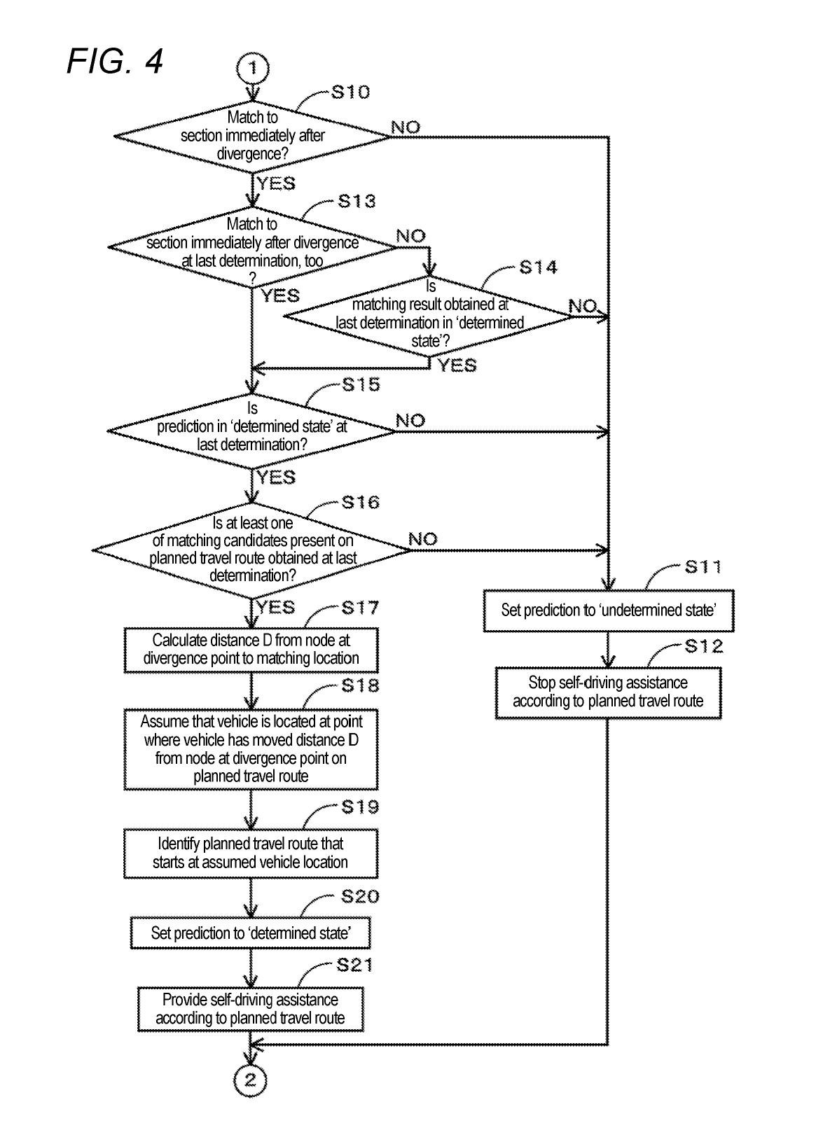

Meanwhile, the navigation ECU (Electronic Control Unit) 13 is an electronic control unit that performs overall control of the navigation device 1, and includes a CPU 41 serving as a computing device and a control device; a storage medium such as RAM 42 that is used as a working memory when the CPU 41 performs various types of arithmetic processing, and that stores route data obtained when a route is searched for, etc.; a storage medium such as ROM 43 having recorded therein a self-driving assistance program which will be described later (see FIGS. 3 and 4), etc., in addition to a program for control; and an internal storage device such as a flash memory 44 that stores a program read from the ROM 43. The navigation ECU 13 has various types of means as processing algorithms. For example, vehicle location detection means detects a location of a vehicle. Planned travel route identification means identifies a planned travel route on which the vehicle travels from now on, based on the location of the vehicle detected by the vehicle location detection means. Driving assistance means provides self-driving assistance of the vehicle according to the planned travel route identified by the planned travel route identification means.

The operating unit 14 is operated, for example, upon inputting a point of departure which is a travel start point and a destination which is a travel end point, and includes a plurality of operating switches (not shown) such as various types of keys and buttons. Then, based on a switch signal outputted by, for example, depression of each switch, the navigation ECU 13 performs control to perform corresponding various types of operation. The operating unit 14 may have a touch panel provided on the front of the liquid crystal display 15. Note also that the operating unit 14 may have a microphone and an audio recognition device.

In addition, on the liquid crystal display 15 there are displayed a map image including a road, traffic information, operation guidance, an operation menu, guidance on keys, guidance information in accordance with a guided route, news, a weather forecast, time, an e-mail, a TV program, etc. In addition, in the present embodiment, when self-driving assistance starts or is cancelled, the liquid crystal display 15 also displays guidance on the start or cancellation of self-driving assistance. An HUD or an HMD may be used instead of the liquid crystal display 15.

In addition, the speaker 16 outputs audio guidance that provides guidance on travel along a guided route or guidance on traffic information, based on an instruction from the navigation ECU 13. In addition, in the present embodiment, when self-driving assistance starts or is cancelled, the speaker 16 also outputs audio guidance on the start or cancellation of self-driving assistance.

Here, for vehicle's travel modes, travel by self-driving assistance in which the vehicle automatically travels along a preset route or road without depending on user's driving operations is possible in addition to manual driving travel in which the vehicle travels based on user's driving operations. In travel by self-driving assistance, for example, a current vehicle location, a lane in which the vehicle travels, and the locations of other vehicles around the vehicle are detected whenever necessary, and vehicle control such as steering, drive sources, and brakes is automatically performed by the vehicle control ECU 20 such that the vehicle travels along a preset route or road. In particular, in the present embodiment, as will be described later, a planned travel route on which the vehicle is planning to travel from now on is identified, and a control operation is set based on the planned travel route.

Specifically, in the present embodiment, the following five types of self-driving assistance are performed according to an identified planned travel route:

(1) ‘Constant-speed travel’ . . . The vehicle travels in the same lane at a predetermined set speed (e.g., 90% of the speed limit of a road on which the vehicle travels).

(2) ‘Following travel’ . . . The vehicle travels in the same lane with a constant distance (e.g., 10 m) maintained between the vehicle and a vehicle ahead, with a set speed (e.g., 90% of the speed limit of a road on which the vehicle travels) being an upper limit.

(3) ‘Speed management (a curve)’ . . . When there is a curve ahead in a traveling direction, the vehicle is decelerated to a speed according to the radius of curvature of the curve before entering the curve.

(4) ‘Speed management (an exit ramp)’ . . . The vehicle suppresses acceleration when traveling in a deceleration lane (an exit ramp) provided on an expressway, etc.

(5) ‘Speed management (a tollgate, a stop, and a traffic light)’ . . . When there is a tollgate, a stop, or a traffic light ahead in a traveling direction, the vehicle is decelerated to a speed (e.g., 20 km/h) at which the vehicle can stop without giving a passenger stress, before reaching the tollgate, stop (traffic sign), or traffic light.

In addition, in parallel to the above-described control (1) to (5), (6) control that allows the vehicle to travel near the center of a lane without deviating from the lane (e.g., lane keeping assist) is also performed.

For example, when a planned travel route does not have a special road shape such as a curve, ‘constant-speed travel’ or ‘following travel’ is basically performed. On the other hand, when a planned travel route includes a special road shape such as a curve, special control according to the road shape (e.g., ‘speed management (a curve)’ or ‘speed management (an exit ramp)’) is performed. In addition, in travel by self-driving assistance of the present embodiment, a lane change and a left or right turn are not made, and the vehicle basically travels in the same lane unless the user performs a vehicle operation for a lane change or a left or right turn.

In addition, the above-described control according to self-driving assistance (1) to (6) may be performed on all road sections, but the configuration may be such that such control is performed only during travel on an expressway provided with a gate at a boundary between a road and another road connected to the road (it does not matter whether the gate is manned or unmanned or whether the gate is a toll or toll-free gate).

When the vehicle travels in a section where the vehicle can perform self-driving (hereinafter, referred to as self-driving section), self-driving assistance is not always provided, but the user selects the provision of self-driving assistance, and self-driving assistance is provided only in a situation in which it is determined that the vehicle is allowed to travel by self-driving assistance. A situation in which the vehicle is not allowed to travel by self-driving assistance includes, for example, a case in which road information required to provide self-driving assistance such as lane markings cannot be obtained.

In addition, the DVD drive 17 is a drive that can read data recorded on a recording medium such as a DVD or a CD. Then, based on the read data, for example, music or video is played back or the map information DB 31 is updated. A card slot for performing reading and writing on a memory card may be provided instead of the DVD drive 17.

In addition, the communication module 18 is a communication device for receiving traffic information, probe information, weather information, etc., which are transmitted from a traffic information center, e.g., a VICS center or a probe center. The communication module 18 corresponds, for example, to a mobile phone or a DCM. In addition, the communication module 18 also includes a vehicle-to-vehicle communication device that performs communication between vehicles and a road-to-vehicle communication device that performs communication with a roadside device.

In addition, the exterior camera 19 is composed of, for example, a camera using a solid-state imaging device such as a CCD. The exterior camera 19 is mounted on the top of a vehicle's front bumper and installed such that its optical axis direction is downward at a predetermined angle with respect to the horizontal. When the vehicle travels in a self-driving section, the exterior camera 19 captures an image of an area in front of the vehicle in the traveling direction. In addition, the vehicle control ECU 20 performs image processing on the captured image which is captured, and thereby detects markings drawn on a road on which the vehicle travels, other vehicles around the vehicle, etc., and provides self-driving assistance of the vehicle based on the detection results. The exterior camera 19 may be configured to be disposed on the rear or side of the vehicle instead of the front of the vehicle. Note also that for means for detecting other vehicles, a sensor such as a millimeter-wave radar, vehicle-to-vehicle communication, or road-to-vehicle communication may be used instead of a camera.

In addition, the vehicle control ECU 20 is an electronic control unit that controls the vehicle having mounted thereon the navigation device 1. In addition, each drive unit of the vehicle such as a steering, brakes, and an accelerator is connected to the vehicle control ECU 20. In the present embodiment, particularly, after the vehicle starts self-driving assistance, the vehicle control ECU 20 controls each drive unit and thereby provides self-driving assistance of the vehicle. In addition, when the user performs an override during self-driving assistance, the vehicle control ECU 20 detects that the override has been performed.

Here, the navigation ECU 13 transmits an instruction signal regarding self-driving assistance to the vehicle control ECU 20 through a CAN after the start of travel. Then, the vehicle control ECU 20 provides self-driving assistance after the start of travel, according to the received instruction signal. The content of the instruction signal is a control operation of self-driving assistance to be provided to the vehicle (e.g., any of the above-described (1) to (6)) or information instructing, for example, to start, stop, or change control. The configuration may be such that instead of the navigation ECU 13, the vehicle control ECU 20 sets a control operation of self-driving assistance.

In that case, the vehicle control ECU 20 is configured to obtain, from the navigation device 1, information required to set a control operation of self-driving assistance, such as a guided route, the state of the vehicle, and map information of an area around the vehicle.

Next, a self-driving assistance program which is executed by the CPU 41 in the navigation device 1 according to the present embodiment that has the above-described configuration will be described based on FIGS. 3 and 4. FIGS. 3 and 4 are flowcharts of the self-driving assistance program according to the present embodiment. Here, the self-driving assistance program is a program that is executed every time the navigation device 1 performs a map matching process for identifying a current vehicle location, and provides self-driving assistance of the vehicle based on the result of the map matching process. In the present embodiment a map matching process for identifying a current vehicle location is performed at predetermined intervals (e.g., every 0.5 ms) with an accessory (ACC) power supply in an on state. Namely, the self-driving assistance program is also executed at the above-described predetermined intervals. In addition, the self-driving assistance program may be configured to be executed only during when self-driving assistance is provided in the vehicle or may be configured to be executed also during when the vehicle is traveling by manual driving. In addition, the program represented by the flowcharts in the following FIGS. 3 and 4 is stored in the RAM 42 or the ROM 43 included in the navigation device 1, and executed by the CPU 41.

First, in the self-driving assistance program, at step (hereinafter, abbreviated as S) 1, the CPU 41 obtains a result of the last map matching process performed by the navigation device 1. Here, map matching is a process in which, when the coordinates of a vehicle location detected by various types of sensors such as the GPS 22, the vehicle speed sensor 23, and the gyro sensor 25 are near a road (link) on a map, the vehicle location is drawn onto the road, by which the vehicle location is modified. Map matching is a publicly-known technique and thus the details of the process are omitted.

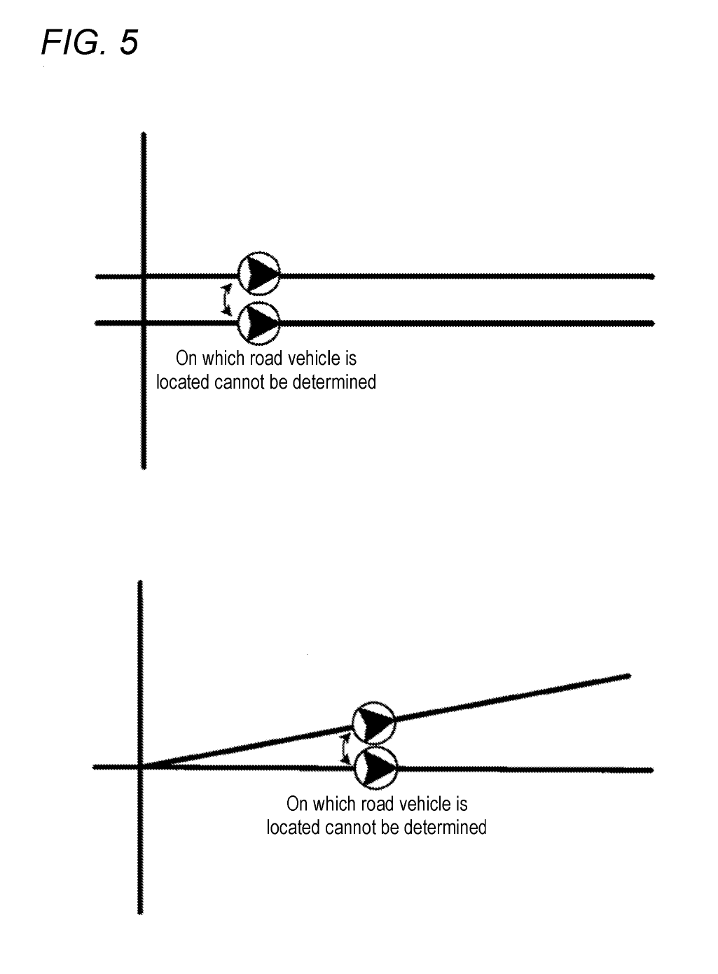

Then, at S2, the CPU 41 determines, for the result of the map matching process obtained at the above-described S1, whether the vehicle location is in a ‘determined state’. Here, in the map matching process, when, for example, as shown in FIG. 5, roads run side by side with very narrow spacing therebetween or roads are connected at an intersection at an acute angle, there may be a plurality of candidates for the vehicle location. When, as shown in FIG. 5, there are a plurality of candidates for the vehicle location, it is determined that the vehicle location is in an ‘undetermined state’. On the other hand, when there is only one candidate for the vehicle location, it is determined that the vehicle location is in a ‘determined state’. When the vehicle location cannot match to a link or in a state in which the vehicle location itself cannot be detected due to an error, etc., it is determined that the vehicle location is in an ‘unknown state’.

Then, if it is determined as a result of the map matching process that the vehicle location is in a ‘determined state’ (S2: YES), processing transitions to S3. On the other hand, if it is determined as a result of the map matching process that the vehicle location is in an ‘undetermined state’ or an ‘unknown state’ (S2: NO), processing transitions to S7.

At S3, the CPU 41 determines, based on the current vehicle location in the determined state, whether a candidate for a planned travel route on which the vehicle travels from now on (a route to be predicted upon providing self-driving assistance) can be identified to be one route. The details of a planned travel route determination process at the above-described S3 will be described below.

First, at the above-described S3, the CPU 41 obtains information on a road ahead in the vehicle's traveling direction from the map information DB 31. For the road information obtained at the above-described S3, information that identifies the location of a divergence point at which one route diverges into a plurality of routes is obtained. Then, when there is no divergence point ahead in the vehicle's traveling direction, since a route on which the vehicle travels from now on is naturally only one route in the current traveling direction, it is determined that a candidate for a planned travel route on which the vehicle travels from now on can be identified to be one route (S3: YES). Thereafter, at S4, the CPU 41 identifies the route in the current vehicle's traveling direction as a planned travel route.

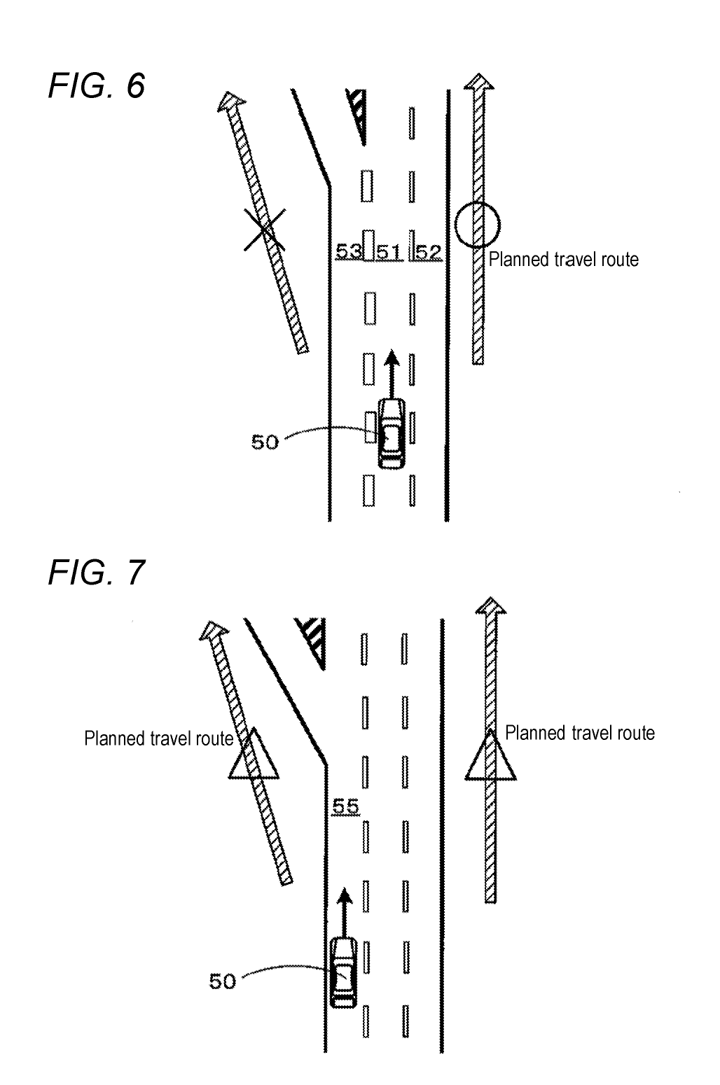

On the other hand, when there is a divergence point ahead in the vehicle's traveling direction, for the divergence point determined to be present ahead in the traveling direction, a road lane division and a connection to a road for each lane (more specifically, the shape of the divergence point, and which lane is connected to which road at the divergence point) are identified from map information stored in the map information DB 31. As described above, the map information DB 31 stores therein the ‘number of lanes’, the ‘type of marking’, and the ‘type of lane connection’, and the CPU 41 identifies a road lane division and a connection to a road for each lane for the divergence point from those pieces of information (FIG. 2). Then, when, in a case of assuming that the vehicle travels without making a lane change, there is only one candidate route on which the vehicle travels from now on, it is determined that a candidate for a planned travel route on which the vehicle travels from now on can be identified to be one route (S3: YES). Thereafter, at S4, the CPU 41 identifies the route along the lane in which the vehicle currently travels, as a planned travel route. For example, when, as shown in FIG. 6, a divergence point at which a route going along lanes 51 and 52 and a route going along a lane 53 diverge is present ahead in a traveling direction of a vehicle 50, and the vehicle 50 is traveling in the lane 51, the route going along the existing lanes 51 and 52 is identified as a planned travel route. A lane in which the vehicle travels is identified using, for example, the exterior camera 19.

On the other hand, when, as shown in FIG. 7, a lane 55 that is identified as a lane in which a vehicle 50 travels does not have a boundary made by a marking and diverges in a plurality of directions at a divergence point, even in a case of assuming that the vehicle travels without making a lane change, there are a plurality of candidate routes on which the vehicle travels from now on. Therefore, it is determined that a candidate for a planned travel route on which the vehicle travels from now on cannot be identified to be one route (S3: NO). Thereafter, processing transitions to S8. Note, however, that as an exception, for a case in which a guided route is set on the navigation device 1, since it is assumed that the vehicle travels along the set guided route from now on, even in the situation shown in FIG. 7, it may be determined that a candidate for a planned travel route on which the vehicle travels from now on can be identified to be one route. In that case, a route along the guided route is identified as a planned travel route.

In travel by self-driving assistance of the present embodiment, as described above, a lane change is not made automatically. Therefore, unless the user intentionally performs a steering operation, the vehicle continuously travels in the same lane as a lane in which the vehicle currently travels, and thus, as described above, a planned travel route can be identified. When the user has made a lane change by performing a steering operation, a new planned travel route is identified by the self-driving assistance program that is executed upon a map matching process performed after the lane change. For example, when, in the situation shown in FIG. 6, the vehicle 50 makes a lane change and enters the lane 53 from the lane 51, a planned travel route going along the lanes 51 and 52 is discarded, and a planned travel route going along the lane 53 is newly identified.

Then, at S5, since one planned travel route on which the vehicle travels from now on has been able to be identified and the CPU 41 is in a state of being able to provide self-driving assistance according to the identified planned travel route, the CPU 41 sets the prediction to a ‘determined state (a state in which self-driving assistance based on a predicted route can be provided)’.

Subsequently, at S6, the CPU 41 provides self-driving assistance based on the identified planned travel route, together with the vehicle control ECU 20. Specifically, the above-described self-driving assistance (1) to (6) is switched as appropriate and provided according to the road shape and road type of the planned travel route, ground objects included in the route, etc. For example, when the planned travel route has a linear shape, ‘constant-speed travel’ or ‘following travel’ is performed. On the other hand, when the planned travel route has a curved shape, ‘speed management (a curve)’ is performed in preparation for traveling of an upcoming curve. Alternatively, when the planned travel route includes a tollgate, a stop, or a traffic light, ‘speed management (a tollgate, a stop, and a traffic light)’ is performed in preparation for passing of the tollgate, stop, or traffic light.

On the other hand, at S7, the CPU 41 determines, for the result of the map matching process obtained at the above-described 51, whether the vehicle location is in an ‘undetermined state’.

Then, if it is determined as a result of the map matching process that the vehicle location is in an ‘undetermined state’ (S7: YES), i.e., when there are a plurality of candidates for the vehicle location, processing transitions to S10 of FIG. 4. On the other hand, if it is determined as a result of the map matching process that the vehicle location is in an ‘unknown state’ (S7: NO), processing transitions to S8.

When the current vehicle location is in an unknown state in which the current vehicle location has not been able to be identified on any road, a planned travel route on which the vehicle travels from now on (a route to be predicted upon providing self-driving assistance) cannot be identified. Therefore, at S8, the CPU 41 sets the prediction to an ‘undetermined state (a state in which self-driving assistance based on a predicted route cannot be provided)’.

Subsequently, at S9, when self-driving assistance has been provided based on a planned travel route, the CPU 41 stops the self-driving assistance based on a planned travel route. The self-driving assistance stopped at the above-described S9 is resumed after the prediction is set later on to a ‘determined state (a state in which self-driving assistance based on a predicted route can be provided)’ (S6 and S21).

On the other hand, at S10 which is performed when it is determined as a result of the map matching process that the vehicle location is in an ‘undetermined state’ (S7: YES), the CPU 41 determines whether the vehicle location identified in the map matching process matches particularly to a “section immediately after divergence.” In the map matching process, even when there are a plurality of candidates for the vehicle location, the vehicle location is basically identified (temporarily identified) to be any one of the plurality of candidates for the location (e.g., a location assumed to be where the vehicle is most likely to be located). At the above-described S10, a determination is made based on the temporarily identified vehicle location.

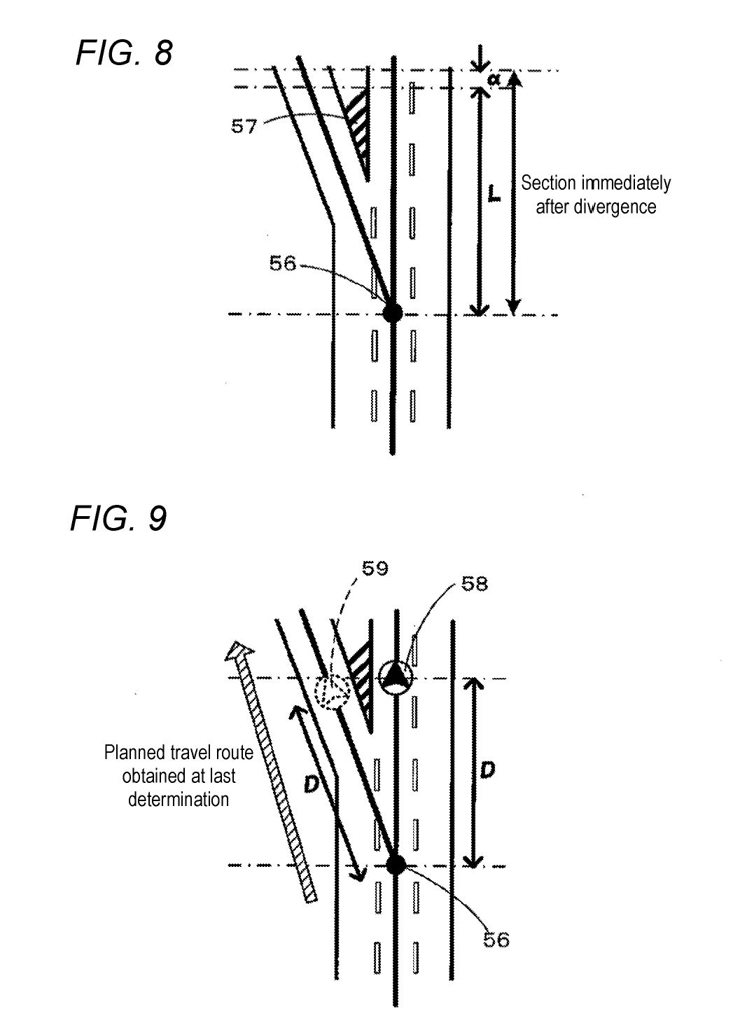

Here, the “section immediately after divergence” is, as shown in FIG. 8, a section within a predetermined distance from a divergence point in a vehicle's traveling direction. In addition, the predetermined distance is a distance obtained by adding a distance a (e.g., 10 m) that takes into account the detection error of the vehicle location, to a distance L from a node 56 corresponding to the divergence point to a point where each route connected to the divergence point physically diverges. Namely, the “section immediately after divergence” is a section where there can be a plurality of candidates for the vehicle location in a map matching process and where the vehicle can change its course between diverged roads (a section where a planned travel route can be changed by a driver's intention and it is difficult to identify a planned travel route from a map-matched vehicle location). A point where each route physically diverges at a divergence point to which roads are connected at an acute angle, such as that shown in FIG. 8, corresponds to an endpoint of a guide zone 57 present between the roads connected to the divergence point.

Then, if it is determined that the vehicle location identified in the map matching process matches to a “section immediately after divergence” (S10: YES), processing transitions to S13. On the other hand, if it is determined that the vehicle location identified in the map matching process does not match to a “section immediately after divergence” (S10: NO), processing transitions to S11.

Here, a case in which the vehicle is located in a section other than a section immediately after divergence and there are a plurality of candidates for the vehicle location is considered to be, for example, a situation in which roads run side by side with very narrow spacing therebetween, such as that shown at the top in FIG. 5. In such a situation, it is difficult to identify a planned travel route on which the vehicle travels from now on (a route to be predicted upon providing self-driving assistance). Therefore, at S11, the CPU 41 sets the prediction to an ‘undetermined state (a state in which self-driving assistance based on a predicted route cannot be provided)’.

Subsequently, at S12, when self-driving assistance has been provided based on a planned travel route, the CPU 41 stops the self-driving assistance based on a planned travel route. The self-driving assistance stopped at the above-described S12 is resumed after the prediction is set later on to a ‘determined state (a state in which self-driving assistance based on a predicted route can be provided)’ (S6 and S21).

On the other hand, at S13, the CPU 41 determines whether it has been determined in the self-driving assistance program executed last time, too, that the vehicle location identified in the map matching process matches to a “section immediately after divergence” as in the self-driving assistance program executed this time. The self-driving assistance program is, as described above, executed at predetermined intervals at which the navigation device 1 performs a map matching process for identifying a current vehicle location.

Then, if it has been determined in the self-driving assistance program executed last time, too, that the vehicle location identified in the map matching process matches to a “section immediately after divergence” (S13: YES), i.e., when the vehicle is located in a section immediately after divergence at the last determination, too, processing transitions to S15. On the other hand, if it has been determined in the self-driving assistance program executed last time that the vehicle location identified in the map matching process matches to a section other than a “section immediately after divergence” (S13: NO), i.e., when at the last determination, the vehicle is before passing through a divergence point, processing transitions to S14.

At S14, the CPU 41 determines whether it has been determined in the self-driving assistance program executed last time and as a result of the map matching process that the vehicle location is a ‘determined state’.

Then, if it has been determined in the self-driving assistance program executed last time and as a result of the map matching process that the vehicle location is a ‘determined state’ (S14: YES), processing transitions to S15. On the other hand, if it has been determined in the self-driving assistance program executed last time and as a result of the map matching process that the vehicle location is an ‘undetermined state’ or an ‘unknown state’ (S14: NO), it is determined that it is difficult to identify a planned travel route on which the vehicle travels from now on (a route to be predicted upon providing self-driving assistance), and processing transitions to S11.

On the other hand, at S15, the CPU 41 determines whether the prediction has been set to a ‘determined state (a state in which self-driving assistance based on a predicted route can be provided)’, i.e., whether one planned travel route on which the vehicle travels from now on has been able to be identified, in the self-driving assistance program executed last time.

Then, if the prediction has been set to a ‘determined state in the self-driving assistance program executed last time (S15: YES), processing transitions to S16. On the other hand, if the prediction has been set to an ‘undetermined state (a state in which self-driving assistance based on a predicted route cannot be provided)’ in the self-driving assistance program executed last time (S15: NO), it is determined that it is difficult to identify a planned travel route on which the vehicle travels from now on (a route to be predicted upon providing self-driving assistance), and processing transitions to S11.

Subsequently, at S16, the CPU 41 determines whether at least one of the candidates for the vehicle location identified in the map matching process performed this time is located on the planned travel route identified in the self-driving assistance program executed last time (hereinafter, referred to as determined planned travel route).

Then, if it is determined that at least one of the candidates for the vehicle location identified in the map matching process is located on the determined planned travel route (S16: YES), processing transitions to S17. On the other hand, if it is determined that none of the candidates for the vehicle location identified in the map matching process are located on the determined planned travel route (S16: NO), it is determined that it is difficult to identify a planned travel route on which the vehicle travels from now on (a route to be predicted upon providing self-driving assistance), and processing transitions to S11.

At S17, the CPU 41 calculates a distance D from a node at a divergence point (hereinafter, referred to as target divergence point) included in the section immediately after divergence to which the vehicle location matches, to the vehicle location identified in the map matching process performed this time. For the distance D, a distance along a route but not a straight-line distance is basically calculated. As described above, in the map matching process, even when there are a plurality of candidates for the vehicle location, the vehicle location is basically identified (temporarily identified) to be any one of the plurality of candidates for the location. At the above-described S17, a distance D to the temporarily identified vehicle location is calculated. The temporarily identified vehicle location is not always located on the determined planned travel route. The distance D calculated at the above-described S17 corresponds to a traveled distance that the vehicle has traveled up to the present time after passing through the target divergence point.

Then, at S18, the CPU 41 assumes that the vehicle is currently located at a location where the vehicle has moved the distance D calculated at the above-described S17 from the node at the target divergence point in the traveling direction and along the determined planned travel route. For example, when a vehicle travels through a divergence point shown in FIG. 9, a vehicle location temporarily identified in a map matching process performed this time is at a point 58 on a link that diverges in a straight-ahead direction, and a determined planned travel route identified in the self-driving assistance program executed last time is a route that goes left at the divergence, a distance D from a node 56 to the point 58 is calculated and then it is assumed that the vehicle is currently located at a point 59 where the vehicle has moved the distance D from the node 56 along the determined planned travel route.

Thereafter, at S19, the CPU 41 identifies a route that starts at the current vehicle location assumed at the above-described S18 within the determined planned travel route, to be a planned travel route on which the vehicle travels from now on (a route to be predicted upon providing self-driving assistance).

Then, at S20, since one planned travel route on which the vehicle travels from now on has been able to be identified and the CPU 41 is in a state of being able to provide self-driving assistance according to the identified planned travel route, the CPU 41 sets the prediction to a ‘determined state (a state in which self-driving assistance based on a predicted route can be provided)’.

Subsequently, at S21, the CPU 41 provides self-driving assistance based on the identified planned travel route, together with the vehicle control ECU 20. Specifically, the above-described self-driving assistance (1) to (6) is switched as appropriate and provided according to the road shape and road type of the planned travel route, ground objects included in the route, etc. For example, when the planned travel route has a linear shape, ‘constant-speed travel’ or ‘following travel’ is performed. On the other hand, when the planned travel route has a curved shape, ‘speed management (a curve)’ is performed in preparation for traveling of an upcoming curve. Alternatively, when the planned travel route includes a tollgate, a stop, or a traffic light, ‘speed management (a tollgate, a stop, and a traffic light)’ is performed in preparation for passing of the tollgate, stop, or traffic light.

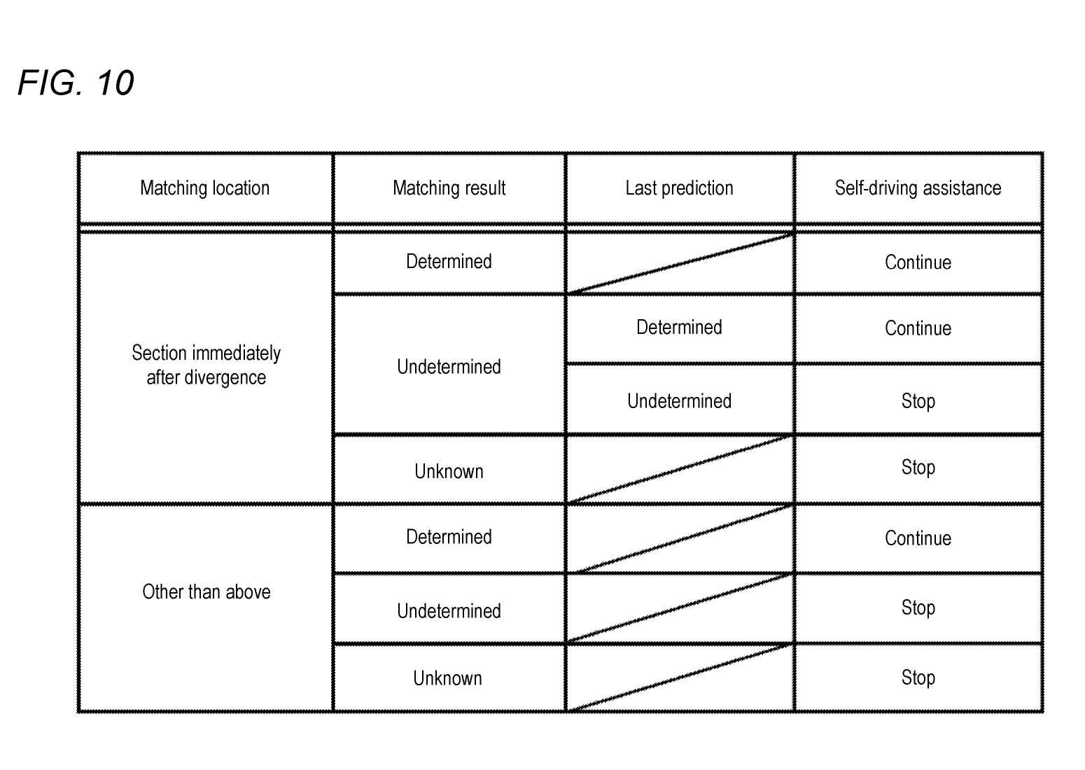

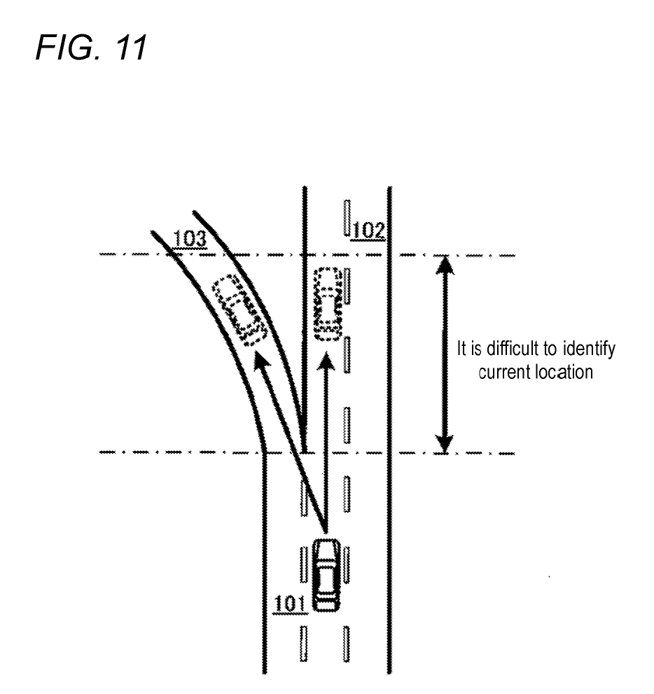

As a result of executing the above-described self-driving assistance program (FIG. 4), in the present embodiment, it is determined whether to continuously provide self-driving assistance, according to a combination of the current vehicle's map matching state (a determined state, an undetermined state, or an unknown state) and whether a planned travel route has been identified at the last determination (a determined state or an undetermined state) as shown in FIG. 10. For example, even if the vehicle is in a section immediately after divergence and the vehicle's map matching state is in an undetermined state (there are a plurality of candidates for the vehicle location), when one planned travel route has been able to be identified at the last determination (note, however, that it is limited to when any of the candidates for the vehicle location is present on the planned travel route), self-driving assistance is continuously provided according to the planned travel route. Namely, according to a planned travel route that is identified before passing through a divergence point and most recently, self-driving assistance is continuously provided while the vehicle is located in a section immediately after divergence including the divergence point.

On the other hand, when the vehicle is in a section immediately after divergence, the vehicle's map matching state is in an undetermined state (there are a plurality of candidates for the vehicle location), and a planned travel route has not been able to be identified at the last determination, self-driving assistance is stopped. Namely, when one planned travel route has not been able to be identified at a stage immediately before passing through a divergence point, self-driving assistance is stopped. Furthermore, when all of a plurality of candidates for the vehicle location identified in a map matching process are off a planned travel route, too, self-driving assistance is stopped.

As described in detail above, in the navigation device 1 according to the present embodiment and a computer program executed by the navigation device 1, even when a plurality of candidates for a vehicle location are detected in a map matching process in a case of a vehicle being in a section immediately after divergence, when one planned travel route has been identified before the vehicle passes through a divergence point, the planned travel route is estimated to be a planned travel route on which the vehicle travels from now on, and self-driving assistance of the vehicle is provided according to the planned travel route (S6 and S21). Thus, it becomes possible to continuously provide self-driving assistance even after passing through a divergence point, based on a planned travel route that is identified with high accuracy before passing through the divergence point. Therefore, self-driving assistance is prevented from being provided in a situation in which self-driving assistance is not supposed to be provided, or an operation of self-driving assistance that differs from an operation originally supposed to be performed is prevented from being performed, enabling to provide appropriate self-driving assistance according to a current vehicle situation.

Various improvements and modifications may, of course, be made without departing from the spirit of the broad inventive principles described herein.

For example, although, in the present embodiment, the configuration is such that even during provision of self-driving assistance, a lane change is made by a user's manual operation, the configuration may be such that a lane change is automatically made by self-driving assistance. In addition, the configuration may be such that a left or right turn, a stop, a start, etc., can also be made by self-driving assistance.

In addition, although, in the present embodiment, the configuration is such that a planned travel route is identified only when self-driving assistance is provided, the configuration may be such that a planned travel route is identified even when a vehicle is traveling by manual driving. By this, even immediately after switching from travel by manual driving to travel by self-driving assistance, it becomes possible to appropriately provide self-driving assistance by using a pre-identified planned travel route.

In addition, in the present embodiment, the control, by the vehicle control ECU 20, of all of an accelerator operation, a brake operation, and a steering wheel operation which are operations related to vehicle behavior among vehicle operations is described as self-driving assistance for automatically performing travel without depending on user's driving operations. However, self-driving assistance may be the control, by the vehicle control ECU 20, of at least one of an accelerator operation, a brake operation, and a steering wheel operation which are operations related to vehicle behavior among vehicle operations. On the other hand, manual driving by user's driving operations is described as the performance, by the user, of all of an accelerator operation, a brake operation, and a steering wheel operation which are operations related to vehicle behavior among vehicle operations.

In addition, although, in the present embodiment, the configuration is such that a self-driving assistance program (FIGS. 3 and 4) is executed by the navigation device 1, the configuration may be such that the self-driving assistance program is executed by the vehicle control ECU 20. In that case, the configuration is such that the vehicle control ECU 20 obtains map matching results, map information, etc., from the navigation device 1.

In addition, devices having a route search function, in addition to a navigation device, can also be used. For example, a mobile phone, a smartphone, a tablet terminal, a personal computer, etc. (hereinafter, referred to as portable terminal, etc.) can all be used. In addition, a system including a server and a portable terminal, etc., can be used. In that case, the configuration may be such that each step of the above-described self-driving assistance program (FIGS. 3 and 4) is performed by either the serve or the portable terminal. Note, however, that when a portable terminal, etc., is used, a vehicle that can provide self-driving assistance and the portable terminal, etc., need to be communicably connected to each other (it does not matter whether the connection is wired or wireless).

In addition, although an implementation example in which a self-driving assistance device is embodied is described above, the self-driving assistance device can also have the following configurations, and in that case the following advantageous effects are provided.

For example, a first configuration is as follows:

The self-driving assistance device includes: vehicle location detection means (41) for detecting a location of a vehicle (50); planned travel route identification means (41) for identifying a planned travel route on which the vehicle travels from now on, based on the location of the vehicle detected by the vehicle location detection means; and driving assistance means (41) for providing self-driving assistance of the vehicle according to the planned travel route identified by the planned travel route identification means (41). When a plurality of candidates for the location of the vehicle are detected by the vehicle location detection means after the vehicle passes through a divergence point, the driving assistance means provides self-driving assistance of the vehicle according to a determined planned travel route, the determined planned travel route being a planned travel route identified by the planned travel route identification means before the vehicle passes through the divergence point.

According to the self-driving assistance device having the above-described configuration, even when there are a plurality of candidates for the current vehicle location after passing through a divergence point, by providing self-driving assistance according to a planned travel route that is identified with high accuracy before passing through the divergence point, self-driving assistance is prevented from being provided in a situation in which self-driving assistance is not supposed to be provided, or an operation of self-driving assistance that differs from an operation originally supposed to be performed is prevented from being performed, enabling to provide appropriate self-driving assistance according to a current vehicle situation.

In addition, a second configuration is as follows:

When a candidate for the planned travel route is identified to be one route by the planned travel route identification means before the vehicle (50) passes through the divergence point, the driving assistance means (41) provides self-driving assistance of the vehicle according to the determined planned travel route.

According to the self-driving assistance device having the above-described configuration, even when there are a plurality of candidates for the current vehicle location after passing through a divergence point, by providing self-driving assistance according to one planned travel route that is determined before passing through the divergence point, it becomes possible to provide appropriate self-driving assistance according to a current vehicle situation.

In addition, a third configuration is as follows:

When any of the plurality of candidates for the location of the vehicle (50) detected by the vehicle location detection means (41) is present on the determined planned travel route, the driving assistance means (41) provides self-driving assistance of the vehicle according to the determined planned travel route.

According to the self-driving assistance device having the above-described configuration, in a situation in which the vehicle is highly likely to be traveling on a planned travel route that is identified before passing through a divergence point, self-driving assistance is provided according to the planned travel route. Thus, it becomes possible to provide appropriate self-driving assistance according to a current vehicle situation.

In addition, a fourth configuration is as follows:

When none of the plurality of candidates for the location of the vehicle (50) detected by the vehicle location detection means (41) are present on the determined planned travel route, the driving assistance means (41) stops self-driving assistance of the vehicle based on the planned travel route.

According to the self-driving assistance device having the above-described configuration, in a situation in which the vehicle is less likely to be traveling on a planned travel route that is identified before passing through a divergence point, self-driving assistance according to the planned travel route is not provided. Thus, it becomes possible to prevent provision of self-driving assistance based on an erroneous planned travel route.

In addition, a fifth configuration is as follows:

The determined planned travel route (41) is a planned travel route identified based on a location of the vehicle, the location being detected before the vehicle (50) passes through the divergence point and most recently by the vehicle location detection means (41).

According to the self-driving assistance device having the above-described configuration, since self-driving assistance is provided according to a planned travel route that is identified at the closest time point to when the vehicle passes through a divergence point, it becomes possible to provide self-driving assistance based on a planned travel route identified with the highest accuracy.

In addition, a sixth configuration is as follows:

When the plurality of candidates for the location of the vehicle (50) detected by the vehicle location detection means (41) are detected within a predetermined distance from the divergence point in a traveling direction, the driving assistance means (41) provides self-driving assistance of the vehicle according to the determined planned travel route.

According to the self-driving assistance device having the above-described configuration, in a situation in which the vehicle is located in a section where it is particularly difficult to identify a current vehicle location that is immediately after passing through a divergence point, a vehicle's planned travel route is estimated, enabling to provide appropriate self-driving assistance.

In addition, a seventh configuration is as follows:

The predetermined distance is set based on a distance from a node (56) corresponding to the divergence point to an endpoint of a guide zone (57) present between roads connected to the divergence point.

According to the self-driving assistance device having the above-described configuration, in a situation in which the vehicle is located in a section where the vehicle can change its course between diverged roads, i.e., a section where a planned travel route can be changed by a driver's intention and it is particularly difficult to identify a planned travel route from a map-matched vehicle location, a vehicle's planned travel route is estimated, enabling to provide appropriate self-driving assistance.

In addition, an eighth configuration is as follows:

The driving assistance means (41): obtains a traveled distance from the divergence point when a plurality of candidates for the location of the vehicle are detected by the vehicle location detection means (41) after the vehicle (50) passes through the divergence point; and provides self-driving assistance of the vehicle assuming that the vehicle is located at a point where the vehicle has moved the traveled distance from the divergence point along the determined planned travel route.

According to the self-driving assistance device having the above-described configuration, even when there are a plurality of candidates for the current vehicle location after passing through a divergence point, the current vehicle location can be accurately estimated using a planned travel route.

In addition, a ninth configuration is as follows:

The self-driving assistance device includes road information obtaining means (41) for obtaining road information that identifies a lane division ahead in a traveling direction of the vehicle (50) and a connection to a road for each lane. The vehicle location detection means detects a lane in which the vehicle travels, and the planned travel route identification means identifies a planned travel route based on the road information and the lane in which the vehicle travels.

According to the self-driving assistance device having the above-described configuration, even when a guided route is not set, by identifying a planned travel route taken by the vehicle from now on from a lane division ahead in a vehicle's traveling direction and a connection to a road for each lane, it becomes possible to more rapidly and accurately identify a planned travel route taken by the vehicle from now on, compared to conventional devices. As a result, it becomes possible to appropriately perform travel by self-driving assistance based on an identified planned travel route.

1. A self-driving assistance device comprising:
a processor programmed to:
detect a location of a vehicle;
identify a planned travel route on which the vehicle travels from now on, based on the detected location of the vehicle; and
provide self-driving assistance of the vehicle according to the identified planned travel route; and
when a plurality of candidates for the location of the vehicle are detected after the vehicle passes through a divergence point, provide self-driving assistance of the vehicle according to a determined planned travel route, the determined planned travel route being a planned travel route identified by the processor before the vehicle passes through the divergence point.

2. The self-driving assistance device according to claim 1, wherein the processor is programmed to:
when a candidate for the planned travel route is identified to be one route before the vehicle passes through the divergence point, provide self-driving assistance of the vehicle according to the determined planned travel route.

3. The self-driving assistance device according to claim 1, wherein the processor is programmed to:
when any of the plurality of candidates for the detected location of the vehicle is present on the determined planned travel route, provide self-driving assistance of the vehicle according to the determined planned travel route.

4. The self-driving assistance device according to claim 3, wherein the processor is programmed to:
when none of the plurality of candidates for the detected location of the vehicle are present on the determined planned travel route, stop self-driving assistance of the vehicle based on the planned travel route.

5. The self-driving assistance device according to claim 4, wherein the determined planned travel route is a planned travel route identified based on a location of the vehicle, the location being a most recent vehicle location detected before the vehicle passes through the divergence point.

6. The self-driving assistance device according to claim 1, wherein the processor is programmed to:
when the plurality of candidates for the detected location of the vehicle are detected within a predetermined distance from the divergence point in a traveling direction, provide self-driving assistance of the vehicle according to the determined planned travel route.

7. The self-driving assistance device according to claim 6, wherein the predetermined distance is set based on a distance from a node corresponding to the divergence point to an endpoint of a guide zone present between roads connected to the divergence point.

8. The self-driving assistance device according to claim 7, wherein the processor is programmed to:
obtain a traveled distance from the divergence point when a plurality of candidates for the location of the vehicle are detected after the vehicle passes through the divergence point; and
provide self-driving assistance of the vehicle assuming that the vehicle is located at a point where the vehicle has moved the traveled distance from the divergence point along the determined planned travel route.

9. The self-driving assistance device according to claim 8, wherein the processor is programmed to:
obtain road information that identifies a lane division ahead in a traveling direction of the vehicle and a connection to a road for each lane;
detect a lane in which the vehicle travels; and
identify the planned travel route based on the road information and the lane in which the vehicle travels.

10. A computer-readable storage medium storing a computer-executable program that causes a computer to perform functions including:
detecting a location of a vehicle;
identifying a planned travel route on which the vehicle travels from now on, based on the detected location of the vehicle; and
providing self-driving assistance of the vehicle according to the identified planned travel route; and
when a plurality of candidates for the location of the vehicle are detected after the vehicle passes through a divergence point, providing self-driving assistance of the vehicle according to a determined planned travel route, the determined planned travel route being a planned travel route identified before the vehicle passes through the divergence point.
